(19) United States
(12) Patent Application Publication
(10) Pub. No.: US 2024/0127586 A1
(43) Pub. Date: Apr. 18, 2024

(54) NEURAL NETWORKS WITH ADAPTIVE GRADIENT CLIPPING

(71) Applicant: DeepMind Technologies Limited, London (GB)

(72) Inventors: Andrew Brock, London (GB); Soham De, London (GB); Samuel Laurence Smith, London (GB); Karen Simonyan, London (GB)

(21) Appl. No.: 18/275,087

(22) PCT Filed: Feb. 2, 2022
(86) PCT No.: PCT/EP2022/052484

§ 371 Date: Jul. 31, 2023

Related U.S. Application Data
(60) Provisional application No. 63/145,922, filed on Feb. 4, 2021.
(60) Provisional application No. 63/149,011, filed on Feb. 12, 2021.

(51) Int. Cl. G06V 10/82; G06V 10/776

(52) U.S. Cl. CPC G06V 10/82; G06V 10/776

(57) ABSTRACT

There is disclosed a computer-implemented method for training a neural network. The method comprises determining a gradient associated with a parameter of the neural network. The method further comprises determining a ratio of a gradient norm to parameter norm and comparing the ratio to a threshold. In response to determining that the ratio exceeds the threshold, the value of the gradient is reduced such that the ratio is equal to or below the threshold. The value of the parameter is updated based upon the reduced gradient value.

### TECHNICAL FIELD

This specification relates to systems and methods for training of neural networks using an adaptive gradient clipping technique.

### BACKGROUND

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

Some neural networks are recurrent neural networks. A recurrent neural network is a neural network that receives an input sequence and generates an output sequence from the input sequence. In particular, a recurrent neural network can use some or all of the internal state of the network from a previous time step in computing an output at a current time step. An example of a recurrent neural network is a long short term memory (LSTM) neural network that includes one or more LSTM memory blocks. Each LSTM memory block can include one or more cells that each include an input gate, a forget gate, and an output gate that allow the cell to store previous states for the cell, e.g., for use in generating a current activation or to be provided to other components of the LSTM neural network.

### SUMMARY

This specification generally describes how a system implemented as computer programs on one or more computers in one or more locations can perform a method to train (that is, adjust the parameters of) a neural network.

In one aspect, there is provided a computer-implemented method for training a neural network comprising determining a gradient associated with a parameter of the neural network. A ratio of a gradient norm to parameter norm is determined and compared to a threshold. In response to determining that the ratio exceeds the threshold, the value of the gradient is reduced such that the ratio is equal to or below the threshold. The value of the parameter is then updated based upon the reduced gradient value.

The method provides an adaptive gradient clipping technique that ensures a stable parameter update. In some neural networks, batch normalization has been required for effective training, for example, in very deep neural networks with hundreds or thousands of layers. The present method enables such neural networks to be trained effectively without the need for batch normalization layers, referred to as “normalizer-free” neural networks herein. Batch normalization introduces dependencies between training data items within a batch which makes implementation on parallel or distributed processing systems more difficult. Batch normalization is also a computationally expensive operation.

By using the adaptive gradient clipping technique described herein to ensure that the ratio of the gradient norm to parameter norm remains within an acceptable range during training, a normalizer-free network can be provided with the same properties as a batch normalized network to replicate the advantageous effects of batch normalization in normalizer-free networks. This provides a more stable parameter update in normalizer-free networks and this stability enables training at large batch sizes which reduces overall training time whilst maintaining task performance. Removal of batch normalization and the dependency of training items within a batch also enables the training to be more easily implemented on parallel or distributed processing systems. The independence of training data items is also important for sequence modelling tasks.

Conventional gradient clipping methods only consider the size of the gradient, they do not take account of the size of the parameter itself and the ratio of a gradient norm to parameter norm. Using conventional gradient clipping methods in normalizer-free networks does not confer the full benefits provided by using the present adaptive gradient clipping method. In particular, training using conventional gradient clipping, the clipping threshold is sensitive to depth, batch size and learning rate and requires fine-grained tuning when varying any of these factors. Diminishing returns are also observed for larger networks when using conventional gradient clipping. The use of a ratio for gradient clipping provides improved stability in the parameter updates that replicates the properties and advantages of batch normalization that conventional gradient clipping fails to do.

In some prior art methods, a ratio is used for adapting a learning rate which also has an effect of scaling the gradient when performing a parameter update step. However, in the present adaptive gradient clipping method, the gradient value is only reduced when the ratio is outside of an acceptable range. This has a significant impact on the network's ability to generalize and maintain task performance. This is particularly the case where computational resources are limited and smaller batch sizes must be used.

The ratio of a gradient norm to parameter norm may be defined as a gradient norm divided by a parameter norm.

The method may further comprise, in response to determining that the ratio is below the threshold, maintaining the value of the gradient and updating the value of the parameter based upon the maintained gradient value. That is, the gradient may be unchanged when the ratio is below the threshold.

Reducing the value of the gradient may comprise multiplying the value of the gradient by a scale factor to reduce the value of the gradient. The scale factor may be based upon the ratio and reducing the value of the gradient may comprise multiplying the value of the gradient by a scale factor based upon the ratio to reduce the value of the gradient. For example, the scale factor may be based upon the inverse of the ratio. Alternatively, or additionally, the scale factor may be based upon the threshold. For example, the threshold may be a value in the range 0.01 to 0.16 inclusive. The scale factor may be based upon a combination of the ratio and threshold. For example, the scale factor may be based upon the threshold multiplied by the inverse of the ratio.

Alternatively, the value of the threshold may be based upon a learning rate. For example, the threshold may be proportional to the inverse of the learning rate. The value of the threshold may also be based upon batch size. For example, a small value for the threshold may be chosen for larger batch sizes (which provides stronger clipping).

The gradient norm and the parameter norm may be determined based upon the parameters associated with one neuron of the neural network. That is, the one neuron may be a single neuron only and the gradient and parameter norms may be unit-wise norms.

The parameter of the neural network may be a weight connected to the neuron of the neural network and the gradient norm may be determined based upon a gradient associated with each respective weight connected to the neuron and the parameter norm may be determined based upon the weight values of each respective weight connected to the neuron.

The gradient norm and the parameter norm may be determined based upon the Frobenius norm. That is, the Frobenius norm of a gradient or parameter matrix associated with a neural network layer may be defined as the square root of the sum of squares of each individual element of the matrix.

The gradient norm may be computed as the Frobenius norm computed over the gradients associated with the respective weights connected to the neuron and the parameter norm may be computed as the Frobenius norm computed over the respective weights connected to the neuron.

Reducing the value of the gradient may be based upon the following equation:

$$\\ {G}_{i}^{{}^{} l} \to λ \frac{{‖ {W}_{i}^{{}^{} l} ‖}_{F}}{{‖ {G}_{i}^{{}^{} l} ‖}_{F}} {G}_{i}^{{}^{} l} if \frac{{‖ {G}_{i}^{{}^{} l} ‖}_{F}}{{‖ {W}_{i}^{{}^{} l} ‖}_{F}} > λ$$

where W^{l} is a weight matrix for the l-th layer, i is an index of a neuron in the l-th layer (and may therefore be a row vector of W^{l}), Gᵢ^{l} is the gradient corresponding to parameters Wᵢ^{l}, λ is a scalar threshold and ∥·∥_{F} is the Frobenius norm. ∥Wᵢ^{l}∥_{F} may also be computed as max(∥Wᵢ^{l}∥_{F}, ε) which can prevent zero-initialized parameters from having their gradients clipped to zero. ε may be 10⁻³ or other small value as appropriate.

The neural network may be a deep residual neural network. The neural network may comprises a residual block and wherein the residual block is normalization layer free. That is, the residual block may not include a batch normalization or other type of normalization layer. The residual block may comprise convolution, pooling and/or non-linear operations but without an activation normalization operation such as batch normalization. The non-linearity may be a Gaussian Error Linear Unit (GELU) or Rectified Linear Unit (ReLU). The convolution operation may be a grouped convolution. For example, the group width of 3×3 convolutions may be 128.

The parameters may be the parameters associated with convolutional layers. Where the parameters are the weights of a convolutional filter, the gradient and parameter norm may be computed over the fan-in extent including the channel and spatial dimensions. The adaptive gradient clipping method may be applied to all layers of the network. The final output layer may however be excluded. An initial convolutional layer may also be excluded.

The neural network may be a deep residual neural network comprising a four stage backbone. A stage may comprise a sequence of residual blocks with activations of constant width and resolution. The backbone may comprise residual blocks in the ratio 1:2:6:3 starting from the first stage to the fourth stage. That is, the first stage may comprise one residual block, the second stage two residual blocks, the third stage six residual blocks and the fourth stage three residual blocks. Networks of increased depth may have increasing numbers of residual blocks in keeping with the specified ratio. For example, a network may have five residual blocks in the first stage, ten residual blocks in the second, thirty in the third stage and fifteen in the fourth stage. Input layers, fully connected layers and output layers typically do not form part of the backbone.

The width of each stage may be double the width of the previous stage. For example, the width may be 256 at the first stage, 512 at the second stage, 1024 at third stage and 2048 at the fourth stage. In an alternative configuration, the width of the third and fourth stages may be 1536. For example, the width may be 256 at the first stage, 512 at the second stage and 1536 at both the third and fourth stages. In another example, the width may be 256 at the first stage, 1024 at the second stage and 1536 at both the third and fourth stages.

The residual block may be a bottleneck residual block. The bottleneck residual block may comprise a first grouped convolutional layer and a second grouped convolutional layer inside the bottleneck. A typical bottleneck only consists of one convolutional layer inside the bottleneck. It has been found that the inclusion of a second convolutional layer in the bottleneck can greatly improve task performance with almost no impact on training time. For example, the bottleneck residual block may comprise a 1×1 convolutional layer that reduces the number of channels to form a bottleneck, a bottleneck comprising a first 3×3 grouped convolutional layer and a second 3×3 grouped convolutional layer, and a 1×1 convolutional layer that restores the number of channels.

The weights of the convolution layers of the residual block may undergo scaled weight standardization. That is, the weights may be reparametrized based upon the mean and standard deviation of the weights in the layer. Further details in relation to scaled weight standardization can be found in Brock et al., “Characterizing signal propagation to close the performance gap in unnormalized resnets”, in 9th International Conference on Learning Representations, ICLR, 2021 which is hereby incorporated by reference in its entirety.

The input of the residual block may be downscaled based upon a variance of the input. The variance may be determined analytically. The final activation of the residual branch of the residual block may be scaled by scalar parameter. The value of the scalar parameter may be 0.2. For example, the residual block may be of the form hᵢ₊₁=hᵢ+αƒᵢ(hᵢ/βᵢ), where hᵢ denotes the inputs to the i-th residual block, and ƒᵢ( ) denotes the function computed by the i-th residual branch. The function may be parameterized to be variance preserving at initialization, such that Var(ƒᵢ(z))=Var(z) for all i. The scalar α may be 0.2 as noted above. The scalar βᵢ may be determined by predicting the standard deviation of the inputs to the i-th residual block, βᵢ=\sqrt{Var(hᵢ)}, where Var(hᵢ₊₁)=Var(hᵢ)+α², except for transition blocks, for which the skip path operates on the downscaled input (hᵢ/βᵢ), and the expected variance is reset after the transition block to hᵢ₊₁=1+α². Further details may also be found in the above referenced Brock et al.

The residual block may further comprise a Squeeze and Excite layer. The Squeeze and Excite layer may process an input activation according to the following sequence of functions: global average pooling, fully-connected linear function, scaled non-linear function, second fully-connected linear function, sigmoid function and linear scaling. For example, the output of the layer may be 2σ(FC(GELU(FC(pool(h)))))×h, where σ is a sigmoid function, FC are fully-connected linear functions, pool is a global average pooling and h is an input activation. The scalar multiplier of 2 may be used to maintain signal variance.

The residual block may further comprise a learnable scalar gain at the end of the residual branch of the residual block. The learnable scalar may be initialized with a value of zero. The learnable scalar may be in addition to the scalar α discussed above.

As noted above, the present adaptive gradient clipping method enables training data items within a batch to be independent and therefore may be used in sequence modelling tasks where batch normalization could not be. Conventional gradient clipping is often used in language modelling and the present adaptive gradient clipping method may provide an advantageous alternative in such applications. Further examples of suitable sequence modelling tasks are provided below. The neural network may be a Transformer type neural network i.e. a neural network including one or more transformer layers. A transformer layer may typically include an attention neural network layer, in particular a self-attention neural network layer, optionally followed by a feedforward neural network. Transformer type neural networks may be used in sequence modelling and are explained in further detail below. The neural network may be a Generative Adversarial Network (GAN) type neural network. GANs are explained in further detail below.

Updating the value of the parameter may be based upon a batch size of at least 1024 training data items. In previous works involving normalizer-free neural networks, training on large batch sizes such as 1024 on ImageNet was unstable. Using the adaptive gradient clipping method, improved stability is provided and training with batch sizes of at least 1024 is enabled. For example, a batch size of 4096 may be used.

The neural network may be pre-trained. For example, the neural network may have undergone training on a different dataset and/or training objective prior to further training on a particular task of interest and/or with a particular dataset of interest. Thus, the network may be pre-trained then fine-tuned. The method may receive a neural network for training as input and may provide an updated neural network as an output.

The method may further comprise receiving a training dataset comprising image data. Determining the gradient may be based upon a loss function for measuring the performance of the neural network on an image processing task.

The computation of the gradient and updating the parameter may be performed based upon stochastic gradient descent or any other appropriate optimization algorithm. The method may be used in combination with regularization methods such as dropout and stochastic depth. The dropout rate may increase with depth. The dropout rate may be in the range 0.2 to 0.5 inclusive. The method may also be used in combination with a momentum-based update rule such as Nesterov's momentum. The method also enables the use of large learning rates to speed-up training due to the improved stability of the training method.

The determination of the gradient may be based upon a sharpness-aware minimization technique. In a sharpness-aware minimization technique, a loss function may comprise a conventional loss based upon a training task and a further loss based upon the geometry of the minima. This further loss seeks parameters that lie in neighbourhoods that have uniformly low loss values. In other words, a flatter minima is sought which is thought to provide better generalization than a sharply shaped minima. The determination of the gradient may comprise performing a gradient ascent step to determine a modified version of the parameter and performing a gradient descent step based upon the modified version of the parameter to determine the gradient associated with the parameter. The gradient ascent step may be performed based upon a subset of the current batch of training data items. For example, one fifth of the training data items in the current batch may be used. When used in conjunction with the adaptive gradient clipping method described above, it has been found that using a subset of the batch results in equivalent performance to using all of the training data items in the batch for the ascent step. Thus, the same benefit can be achieved at a much lower computational cost. When used in a distributed training system, the gradients in the gradient ascent step do not require synchronization between the replicas on different processing units. The gradient ascent step and the generated modified parameters can be kept local to the processing unit and the gradient descent step performed on the local modified parameters. The same effect may be achieved through gradient accumulation for distributed systems with fewer processing units or single processing unit systems. Further details with respect to sharpness-aware minimization can be found in Foret et. al., “Sharpness-aware minimization for efficiently improving generalization”, in 9th International Conference on Learning Representations, ICLR, 2021 available at https://openreview.net/forum?id=6TmlmposlrM which is hereby incorporate by reference in its entirety.

The training dataset may be augmented using a data augmentation technique such as RandAugment. The enhanced stability provided by the adaptive gradient clipping method enables strong augmentation to be used without degrading task performance. On image data, RandAugment provides a selection of image transformations including: identity, auto-contrast, equalize, rotate, solarize, color, posterize, contrast, brightness, sharpness, shear and translate. Modified versions of a training data item may be generated by randomly selecting one or more transformations. Further details regarding RandAugment can be found in Cubuk et. al., “Randaugment: Practical automated data augmentation with a reduced search space”, in Proceedings of the IEEE/CVF Conference on Computer Vision and Pattern Recognition Workshops, pp. 702-703, 2020 which is hereby incorporated by reference in its entirety. It will be appreciated that other sets of transformations may be used as appropriate depending on the modality of the training data items.

Additionally, or alternatively, other data augmentation techniques may be used. For example, a modified training data item may be generated by selecting a portion of a first training data item and replacing a corresponding portion in a second training data item with the selected portion from the first training data item to generate to the modified training data item. The location and size of the selected portion may be randomly selected. A plurality of portions may be selected and used for replacement to generate the modified training data item. In the case of image data, the portion may be an image patch. The modified training data item may be assigned a label based upon the proportion of the first and second training data items that are present in the modified training data item. For example, if the selected portion of the first training data item makes up 40% of the modified training data item and the second training data item makes up the remaining 60%, the label for the modified training data item may be 0.4 for the class associated with the first training data item and 0.6 for the class associated with the second training data item. In a similar data augmentation technique, the selected portion of the first training data item may be blanked out, that is the pixel values may be set to a zero value or a value representing black, or may be replaced with random noise.

Another exemplary data augmentation technique includes generating a modified training data item by interpolating a first and second training data item. The interpolation may be a linear interpolation. The modified training data item may be assigned a label based upon the interpolation weighting of the first and second training data items.

In one implementation, for a batch of training data items, RandAugment may be applied to all of the training data items in the batch, the portion selection/replacement technique may be applied to half of the training data items in the batch and the interpolation technique may be applied to the remaining half of the training data items to generate augmented training data items for the batch. As noted above, the enhanced stability provided by the adaptive gradient clipping method enables strong augmentation to be used without degrading task performance. Thus, a combination of different data augmentation techniques can be beneficial for improving task performance, with task performance improving progressively with stronger data augmentations. Typical batch-normalized neural networks do not benefit from using stronger data augmentations and in some cases can harm their performance.

The method may be performed by a parallel or distributed processing system comprising a plurality of processing units. The method may further comprise receiving a training data set comprising a plurality of training data items; generating a plurality of batches of training data items, each batch comprising a subset of the training data items of the training data set; distributing the plurality of batches of training data items to the plurality of processing units; and training the neural network, using the plurality of processing units in parallel, based upon the distributed plurality of batches of training data items. The plurality of processing units may be part of different physical computing apparatus and/or located in different physical locations.

The method may be carried out by one or more tensor processing units or one or more graphics processing units or other type of accelerator hardware. The parallel or distributed processing system may comprise the one or more graphics processing units or tensor processing units.

According to another aspect, there is provided a system comprising one or more computers and one or more storage devices storing instructions that when executed by the one or more computers cause the one or more computers to perform the operations of the respective methods described above.

The system may be a parallel or distributed processing system. The system may comprise one or more tensor processing units or one or more graphics processing units.

According to a further aspect, there is provided one or more computer storage media storing instructions that when executed by one or more computers cause the one or more computers to perform the operations of the respective methods described above.

The subject matter described in this specification can be implemented in particular embodiments so as to realize one or more of the following advantages

Batch normalization has been an important technique for enabling the training of very deep neural networks, for example, neural networks with hundreds or even thousands of layers. Batch normalization improves the stability of training and enables large batch sizes to be used during training which can greatly reduce overall training time. However, batch normalization is a computationally expensive operation, both in terms of compute and memory, which negates some of the benefit of using larger batch sizes. For example, it has been estimated that batch normalization accounts for approximately one quarter of the training time of a ResNet-50 architecture on ImageNet using a Titan X Pascal GPU.

In addition, batch normalization introduces a dependency between the training data items within a batch. This increases the difficulty of implementing training on parallel or distributed processing systems and using accelerator hardware such as tensor processing units and graphics processing units which may be needed to train very deep neural networks efficiently. Batch normalization is also particularly sensitive to the underlying hardware used for carrying out the training and results can be difficult to replicate on other hardware systems.

Previous work to replace batch normalization has produced networks that provide comparable accuracy on benchmark datasets such as ImageNet. However, at large batch sizes, e.g. greater than 1024 on ImageNet, task performance begins to degrade in these “normalizer-free” networks.

As discussed above, the inventors have identified a significant difference in the ratio of the gradient norm to parameter norm between batch normalized networks and normalizer-free networks during training. Thus, the advantageous effects of batch normalization can be replicated in normalizer-free networks using the adaptive gradient clipping technique described herein to ensure that the ratio of the gradient norm to parameter norm remains within an acceptable range during training, thereby providing a more stable parameter update. This stability enables training at large batch sizes to improve training efficiency for normalizer-free networks whilst maintaining high task performance. For example, a neural network trained using the adaptive gradient clipping technique that matches the test accuracy of a state-of-the-art EfficientNet-B7 network on ImageNet is up to 8.7×faster to train.

In addition, the computational and memory cost of gradient clipping is far lower than batch normalization. Further, as there are no dependencies on the training data items within the batch, training can be carried out on parallel and distributed processing systems more easily. There need not be any special considerations as to how training data items are allocated to batches or the parallel computation of batch statistics. Thus, the training method is particularly adapted for parallel and distributed processing systems and accelerator hardware.

On the other end of the spectrum, the adaptive gradient clipping method is effective at small batch sizes as well as large batch sizes, whereas the task performance of batch normalization and other normalized optimizers tends to be poor. Thus, the adaptive gradient clipping method is also effective where computational resources are limited.

The enhanced stability provided by the adaptive gradient clipping method also enables training with strong data augmentations such as RandAugment which further improves the network's generalization capability and task performance.

### BRIEF DESCRIPTION OF THE DRAWINGS

FIG. 1 shows an example neural network training system.

FIG. 2 shows a schematic illustration of a neural network.

FIG. 3 is flowchart showing processing for training a neural network.

FIG. 4 shows a schematic illustration of a residual neural network architecture.

FIG. 5 shows a schematic illustration of a bottleneck residual block.

FIG. 6 is a graph showing a plot of training latency against image recognition accuracy for exemplary embodiments and a variety of prior art neural network models.

Like reference numbers and designations in the various drawings indicate like elements.

### DETAILED DESCRIPTION

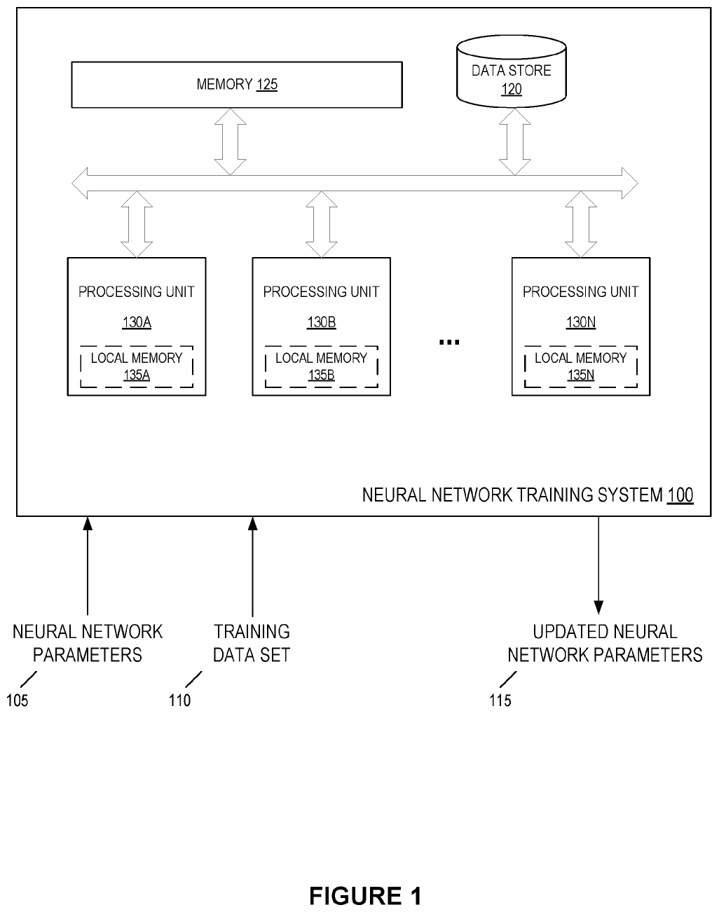

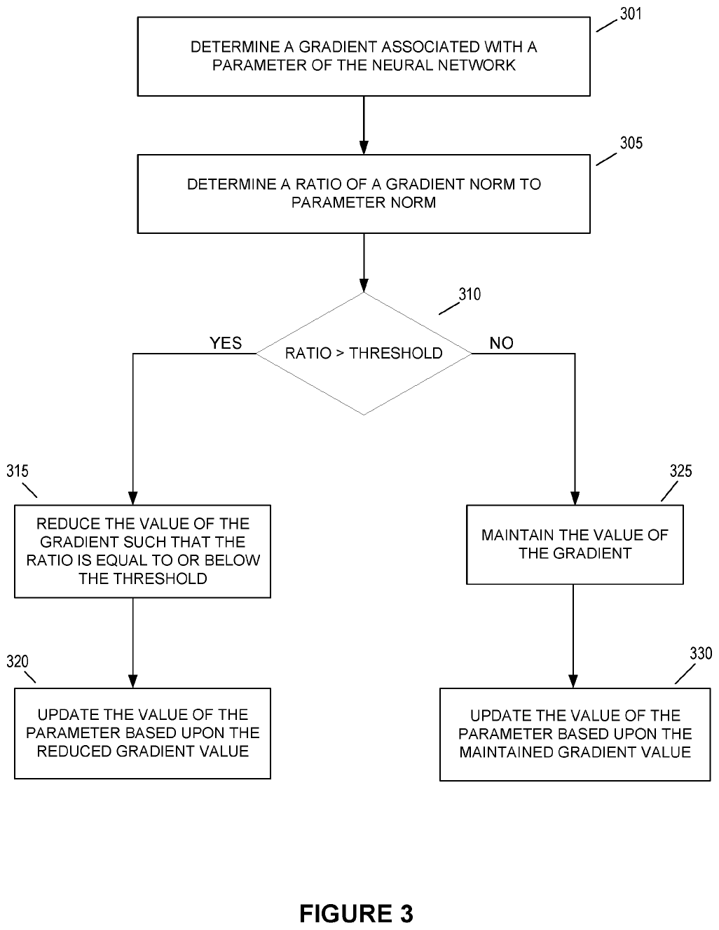

FIG. 1 shows an example neural network training system 100 for training a neural network. A set of neural network parameters 105 of a neural network and a training data set 110 may be provided as input to the neural network training system 100. The neural network training system 100 is configured to process the neural network parameters 105 and the training data set 110 to provide updated neural network parameters 115. That is, the values of the input neural network parameters 105 may be changed in an attempt to improve the performance of the neural network on a particular pre-defined task. In particular, the neural network training system 100 is configured to use an adaptive gradient clipping technique for updating the neural network parameters 105. In the adaptive gradient clipping technique, a gradient associated with a parameter 105 of the neural network is determined. A ratio of a gradient norm to parameter norm is determined and compared to a threshold. In response to determining that the ratio exceeds the threshold, the value of the gradient is reduced such that the ratio is equal to or below the threshold and the value of the parameter is updated based upon the reduced gradient value. Further details in relation to the adaptive gradient clipping technique are provided below with reference to FIG. 3. The neural network training system 100 may be configured to provide the updated neural network parameter 115 as an output.

The neural network training system 100 may alternatively retrieve the input neural network parameters 105 and/or the training data set 110 from a data store 120 or memory 125 local to the system 100. The neural network training system 100 may also be configured to generate an initial set of values for the parameters of the neural network. The neural network training system 100 may also be configured to repeatedly update the neural network parameters 105 until a pre-defined stopping criteria is reached and the final set of updated neural network parameters 140 may be provided as output.

The training data set 110 may comprise a plurality of training data items appropriate to the task and optionally a set of labels corresponding to the target output that the neural network should produce when processing the training data item. For example, the training data set 100 may comprise image data, video data, audio data, speech data, sensor data, data characterizing the state of an environment and other types of data as discussed in more detail below. The tasks may include image recognition, object detection, image segmentation, speech recognition, machine translation, generating an action for controlling a robotic/mechanical/electrical agent and other tasks as discussed in more detail below.

In general, the neural network training system 100 may comprise a plurality of processing units 130A . . . N with each processing unit comprising a local memory 135A . . . N. Thus, the neural network training system 100 in FIG. 1 may be considered to be a parallel or distributed processing system. It will be appreciated that the processing units 130A . . . N may be arranged in a variety of different architectures and configurations as deemed appropriate by a person skilled in the art. For example, the neural network training system 100 may be implemented using a graphics processing unit (GPU) or tensor processor unit (TPU) or any type of neural network accelerator hardware. It will be appreciated that the processing units 130A . . . N may be distributed across a plurality of separate hardware devices in different physical locations communicating via an appropriate computer network and need not be located on a single hardware device.

The neural network training system 100 may be configured to generate a plurality of batches of training data items, each batch comprising a subset of the training data items of the training data set 110. Alternatively, the received training data set 110 may be pre-divided into batches. The neural network training system 100 may be configured to distribute the plurality of batches of training data items to the plurality of processing units 130A . . . N. The neural network system 100 may be configured to train the neural network using the parallel processing capabilities of the plurality of processing units 130A . . . N based upon the plurality of batches of training data items distributed to each processing unit 130A . . . N. The use of the term “batch” in this context is intended to cover any grouping of training data items for distribution to processing units 130A . . . N. For example, when using stochastic gradient descent for training a neural network, a gradient may be computed on the basis of a “mini-batch” of training data items. This “mini-batch” of training data items may be further sub-divided for distribution to the plurality of the processing units 130A . . . N. For example, each processing unit 130A . . . N may be configured to process 32 training data items each. The term “batch” is intended to include such further sub-divisions in the context of distributing training data items to processing units 130A . . . N. Where a “batch size” is referred to in this disclosure, this may be the number of training data items that are used to determine a gradient and update value. As such, this may refer to the size of a “mini-batch” in stochastic gradient descent prior to a sub-division of the mini-batch and distribution to processing units 130A . . . N.

The plurality of processing units 130A . . . N may each be configured to compute the corresponding network outputs for training data items allocated to it in accordance with the current values of neural network parameters 105 in parallel. As discussed in more detail below, the adaptive gradient clipping technique does not have any dependencies between training data items when computing the network output and as such, computing the network output may be carried out by each processing unit 130A . . . N in parallel and independently. This is in contrast to neural networks that include batch normalization layers which introduce dependencies between training data items and thus, may require communication between processing units 130A . . . N to carry out the batch normalization operation or to alternatively introduce data shuffling operations which incurs further overhead. The adaptive gradient clipping technique enables neural networks without batch normalization layers to achieve comparable if not better task performance than neural networks that include batch normalization layers whilst also being easier to implement and to run more efficiently on parallel and distributed systems.

Each processing unit 130A . . . N may be configured to compute an error value or other learning signal based upon the determined network outputs and a particular loss function being used for training the neural network. The error value may be backpropagted through the network to compute a gradient value on the particular batch allocated to the processing unit 130A . . . N in parallel. The computed gradient values determined by each of the processing units 130A . . . N may be combined to determine the ratio of the gradient norm to parameter norm and the update to the values of the parameters in accordance with the adaptive gradient clipping technique. The update to the parameter values may be transmitted to each of the processing units 130A . . . N for applying the update to local copies of the parameters or the updated values themselves may be transmitted to each of the processing units 130A . . . N when further training is required. It will be appreciated that other parallel implementations may be suitable for implementing the adaptive gradient clipping technique. For example, an asynchronous parallel implementation may be used whereby the local copies of the parameters of the neural network used by the processing units 130A . . . N are allowed to differ. The determination of the ratio of the gradient norm to parameter norm, comparison of the ratio to the threshold and updating of the parameter values may be carried out in parallel and independently based upon the batch of training data items distributed to the processing unit. The updating of parameter values and distribution of updated parameter values to processing units 130A . . . N may be performed in accordance with appropriate asynchronous stochastic gradient descent methods for example.

Whilst FIG. 1 depicts a parallel/distributed processing system, it will be appreciated that the neural network training system 100 need not be implemented as a parallel or distributed system and may be implemented using a single processing unit.

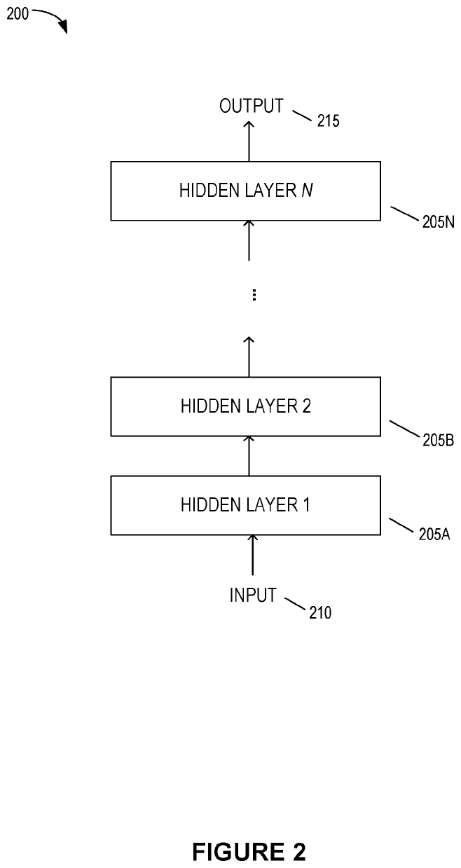

FIG. 2 shows an example neural network 200 comprising a plurality of hidden layers 205A . . . N. The neural network 200 process an input 210 through the plurality of hidden layers 205A . . . N to provide an output 215. Typically, the neural network 200 is trained to perform a particular task. For example, the neural network 200 may be trained to perform an image recognition task. The input 210 may be an image comprising pixel values (or other image data) and the output 215 may be a set of scores representing the likelihood that a particular object is present in the image.

The neural network 200 may be trained using the using conventional techniques such as stochastic gradient descent or other gradient-based methods but modified to use an adaptive gradient clipping technique as described below. In general, for gradient-based training methods, one or more training data items are provided as input to the neural network 200 to generate corresponding outputs. A loss function that compares the generated outputs to corresponding target outputs may be constructed such as a cross-entropy loss. An error value or other learning signal computed from the loss function may be “backpropagated” through the network starting from the output, through the plurality of hidden layers 205A . . . N in reverse order and back to the input. In this way, the gradient of the loss function with respect to each parameter of the neural network may be computed and used to update the parameter value.

In the adaptive gradient clipping technique, a gradient associated with a parameter of the neural network is computed as normal. However, the gradient may be modified prior to its use in updating the parameter. In particular, as shown in the processing of FIG. 3, at step 305, a ratio of a gradient norm to a parameter norm is determined after a gradient associated with the parameter of the neural network is determined at step 301. The ratio may be defined as the gradient norm divided by the parameter norm. At step 310, the determined ratio is compared to a threshold. At step 315, in response to the determining that the ratio exceeds a threshold, the value of the gradient is reduced such that the ratio is equal to or below the threshold, thereby “clipping” the gradient. At step 320, the value of the parameter is updated based upon the reduced gradient value. At step 325, if the ratio does not exceed the threshold, the value of the gradient may be maintained and the value of the parameter may be updated based upon the maintained gradient value at step 330. The update of the parameter value in either case may be carried out according to the particular parameter update rule of the particular gradient-based training method being employed.

The adaptive gradient clipping technique ensures a stable parameter update in that the update to a parameter is limited to a particular size taking account of the scale of the parameter. In some neural networks, batch normalization has been required for effective training, for example, in very deep neural networks with tens, hundreds or even thousands of layers. The present adaptive gradient clipping technique enables such neural networks to be trained effectively without the need for batch normalization layers. Neural networks without batch normalization layers are referred to as “normalizer-free” neural networks herein.

Batch normalization layers take as input, the output of a hidden layer in a neural network, and re-centers and re-scales the input. Initially, the input is modified such that the data has approximately zero-mean and unit variance. A further scaling and shifting based upon learnable parameters may be applied if the initial normalization turns out to be sub-optimal.

The mean and variance for batch normalization is computed on the basis of a batch of training data items used for a particular parameter update step. Thus, batch normalization introduces dependencies between training data items within a batch which makes implementation on parallel or distributed processing systems more difficult as communication between processing units may be required to compute the mean and variance of a batch of data where the batch of data is split between processing units when computing the output of the neural network. Without batch normalization, processing units can compute the network output for each input data item independently, no communication between processing units is necessary. Thus, replacing batch normalization with the adaptive gradient clipping technique removes the dependency of training data items within a batch and restores the ability of processing units to compute the network output independently. This enables the training to be more easily implemented parallel or distributed processing systems and the amount of communication required between processing units in the parallel or distributed system is reduced, thereby improving the efficiency of the parallel implementation. In some prior art implementations, as an alternative to communicating batch normalization statistics between processing units, the training data items within a batch may be shuffled each time batch normalization is to be run such that the processing units are likely to be allocated different subsets of the batch on each run. This shuffling operation however also incurs additional overhead that reduces the efficiency of a parallel/distributed implementation. The use of the adaptive gradient clipping technique avoids the need for a shuffling operation and reduces the overhead in the parallel/distributed implementation.

Normalizer-free neural networks trained with the adaptive gradient clipping technique provides comparable if not better task performance than neural networks with batch normalization. The increased stability achieved through the adaptive gradient clipping technique enables training at large batch sizes which reduces overall training time whilst maintaining task performance. Batch normalization is also a computationally expensive operation and its replacement also contributes to reducing the computational requirements of training large-scale neural networks.

Conventional gradient clipping methods only consider the size of the gradient, they do not take account of the size of the parameter itself and the ratio of a gradient norm to parameter norm. Using conventional gradient clipping methods in normalizer-free networks does not confer the full benefits provided by using the adaptive gradient clipping technique. In particular, training using conventional gradient clipping, the clipping threshold is sensitive to depth, batch size and learning rate and requires fine-grained tuning when varying any of these factors. Diminishing returns are also observed for larger networks when using conventional gradient clipping. The use of a ratio for gradient clipping provides improved stability in the parameter updates that replicates the properties and advantages of batch normalization that conventional gradient clipping fails to do.

Further details of the adaptive gradient technique will now be described. The value of the gradient may be reduced by multiplying the value of the gradient by a scale factor. In one example, the scale factor is based upon the threshold. In another example, the scale factor is based upon the ratio and may be based upon the inverse of the ratio. The scale factor may be based upon a combination of the threshold and ratio, for example, the scale factor may be based upon the threshold multiplied by the inverse of the ratio.

The gradient norm and the parameter norm may be based upon the Frobenius norm. The Frobenius norm of a matrix, A, is defined as the square root of the sum of squares of each individual element of the matrix:

$$\\ {‖ A ‖}_{F} = \sqrt{{\sum }_{i}^{N} {\sum }_{j}^{M} {( {A}_{i , j} )}^{2}}$$

The norm may be a unit-wise norm, that is, the norm may be computed based upon the gradients/parameter values associated with one particular neuron of the neural network in one particular layer. For example, the norm may be computed based upon the parameters associated with incoming connections to the neuron and their corresponding gradients. Alternatively, if appropriate, the outgoing connections may be used.

In one implementation, the value of the gradient may be reduced and updated based upon the following equation:

$$\\ {G}_{i}^{{}^{} l} \to λ \frac{{‖ {W}_{i}^{{}^{} l} ‖}_{F}}{{‖ {G}_{i}^{{}^{} l} ‖}_{F}} {G}_{i}^{{}^{} l} if \frac{{‖ {G}_{i}^{{}^{} l} ‖}_{F}}{{‖ {W}_{i}^{{}^{} l} ‖}_{F}} > λ$$

where W^{l} is a weight matrix for the l-th layer, i is an index of a neuron in the l-th layer (and may therefore be a row vector of W^{l} when the norm is computed unit-wise), Gᵢ^{l} is the gradient corresponding to parameters Wᵢ^{l}, λ is a scalar threshold and ∥·∥_{F} is the Frobenius norm. ∥Wᵢ^{l}∥_{F} may also be computed as max(∥Wᵢ^{l}∥_{F}, ε) which can prevent zero-initialized parameters from having their gradients clipped to zero. ε may be 10⁻³ or other small value as appropriate.

In one example, the threshold may be a value in the range 0.01 to 0.16 inclusive. It will be appreciated that other threshold values may be chosen as appropriate depending on the type of network and batch size of the training data items being processed in one particular parameter update step. The value of the threshold may be based upon the batch size. For example, a small value for the threshold may be chosen for larger batch sizes (which provides stronger gradient clipping).

Updating the value of the parameter may be based upon a batch size of at least 1024 training data items. In previous works involving normalizer-free neural networks, training on large batch sizes such as 1024 on ImageNet was unstable. As discussed above, using the adaptive gradient clipping technique, improved stability is provided and training with batch sizes of at least 1024 is enabled. For example, a batch size of 4096 may be used.

The adaptive gradient clipping technique is also effective at small batch sizes as well as large batch sizes. Task performance of batch normalization and other normalized optimizers tends to be poor on small batch sizes. Thus, the adaptive gradient clipping method is also effective where computational resources are limited and small batch sizes must be used.

The adaptive gradient clipping technique may be used in combination with regularization methods such as dropout and stochastic depth. The dropout rate may increase with depth. That is, the dropout rate may be larger for networks with a larger number of layers. The dropout rate may be in the range 0.2 to 0.5 inclusive. The adaptive gradient clipping technique may also be used in combination with a momentum-based update rule such as Nesterov's momentum. The adaptive gradient clipping technique also enables the use of large learning rates to speed-up training due to the improved stability of the training method.

The determination of the gradient may be based upon a sharpness-aware minimization technique. In a sharpness-aware minimization technique, a loss function may comprise a conventional loss based upon a training task and a further loss based upon the geometry of the minima. This further loss seeks parameters that lie in neighbourhoods that have uniformly low loss values. In other words, a flatter minima is sought which is thought to provide better generalization than a sharply shaped minima. The determination of the gradient may comprise performing a gradient ascent step to determine a modified version of the parameter and performing a gradient descent step based upon the modified version of the parameter to determine the gradient associated with the parameter. The gradient ascent step may be performed based upon a subset of the current batch of training data items. For example, one fifth of the training data items in the current batch may be used. When used in conjunction with the adaptive gradient clipping technique, it has been found that using a subset of the batch results has equivalent performance to using all of the training data items in the batch for the ascent step. Thus, the same benefit can be achieved at a much lower computational cost. When used in a distributed training system, the gradients in the gradient ascent step do not require synchronization between the replicas on different processing units. The gradient ascent step and the generated modified parameters can be kept local to the processing unit and the gradient descent step performed on the local modified parameters. The same effect may be achieved through gradient accumulation for distributed systems with fewer processing units or single processing unit systems. Further details with respect to sharpness-aware minimization can be found in Foret et. al., “Sharpness-aware minimization for efficiently improving generalization”, in 9th International Conference on Learning Representations, ICLR, 2021 available at https://openreview.net/forum?id=6TmlmposlrM which is hereby incorporated by reference in its entirety.

Referring back to FIG. 1, the neural network training system 100 may be configured to augment the training data set 110 to generate further training data items. In addition, or alternatively, the received the training data set 100 may be an augmented training data set comprising a set of unmodified training data items together with modified training data items.

The enhanced stability provided by the adaptive gradient clipping technique enables strong augmentation to be used without degrading task performance. One exemplary data augmentation technique that may be used is referred to as “RandAugment”. Details regarding RandAugment can be found in Cubuk et. al., “Randaugment: Practical automated data augmentation with a reduced search space”, in Proceedings of the IEEE/CVF Conference on Computer Vision and Pattern Recognition Workshops, pp. 702-703, 2020 which is hereby incorporated by reference in its entirety. In brief however, on image data, RandAugment provides a selection of image transformations including: identity, auto-contrast, equalize, rotate, solarize, color, posterize, contrast, brightness, sharpness, shear and translate. It will be appreciated that other sets of transformations may be used as appropriate depending on the modality of the training data items. Modified versions of a training data item may be generated by randomly selecting one or more transformations. In one example, four transformations are randomly selected to be applied sequentially on a training data item to generate a modified training data item for use in training a neural network with the adaptive gradient clipping technique.

Additionally, or alternatively, other data augmentation techniques may be used. For example, a modified training data item may be generated by selecting a portion of a first training data item and replacing a corresponding portion in a second training data item with the selected portion from the first training data item to generate to the modified training data item. The location and size of the selected portion may be randomly selected. Instead of a single portion, a plurality of portions may be selected and used for replacement to generate the modified training data item. In the case of image data, the portion may be an image patch.

A training data item modified in this way may be assigned a label based upon the proportion of the first and second training data items that are present in the modified training data item. For example, if the selected portion of the first training data item makes up 40% of the modified training data item and the second training data item makes up the remaining 60%, the label for the modified training data item may be 0.4 for the class associated with the first training data item and 0.6 for the class associated with the second training data item. In a similar data augmentation technique, the selected portion of the first training data item may be blanked out, that is the pixel values may be set to a zero value or a value representing black, or may be replaced with random noise.

Another exemplary data augmentation technique suitable for use with the adaptive gradient clipping technique includes generating a modified training data item by interpolating a first and second training data item. The interpolation may be a linear interpolation. The modified training data item may be assigned a label based upon the interpolation weighting of the first and second training data items.

In one implementation, for a batch of training data items, RandAugment may be applied to all of the training data items in the batch, the portion selection/replacement technique may be applied to half of the training data items in the batch and the interpolation technique may be applied to the remaining half of the training data items to generate further training data items for the batch. As noted above, the enhanced stability provided by the adaptive gradient clipping method enables strong augmentation to be used without degrading task performance. Thus, a combination of different data augmentation techniques can be beneficial for improving task performance. It has been observed that task performance can progressively improve with stronger data augmentations. Typical batch-normalized neural networks do not benefit from using stronger data augmentations and in some cases can harm their performance.

The received neural network parameters 105 may be the parameters of a pre-trained neural network and the neural network training system 100 may be used to further train the neural network. For example, the neural network may have undergone training on a different dataset and/or training objective prior to further training on a particular task of interest and/or with a particular dataset of interest. Thus, the neural network training system 100 may be used in the context of transfer learning. In one example, a neural network is pre-trained on a dataset that comprises approximately 300 million labeled images from 18,000 classes. The neural network is then fine-tuned for image recognition on the ImageNet dataset. Both the pre-training and fine-tuning stages may be carried out using the neural network training system 100 and the adaptive gradient clipping technique.

The adaptive gradient clipping technique may applied to a neural network having a deep residual neural network architecture. A residual neural network architecture comprises a residual block and as discussed above, using the adaptive gradient clipping technique, the residual block may be normalization layer free. The residual block may comprise operations such as convolution, pooling and/or other linear and non-linear operations but without a batch normalization operation.

In convolutional layers, the gradient and parameter norm may be computed over the fan-in extent including the channel and spatial dimensions. The adaptive gradient clipping technique may be applied to all layers of the network however, the final output layer may be excluded and the initial convolutional layer may also be excluded.

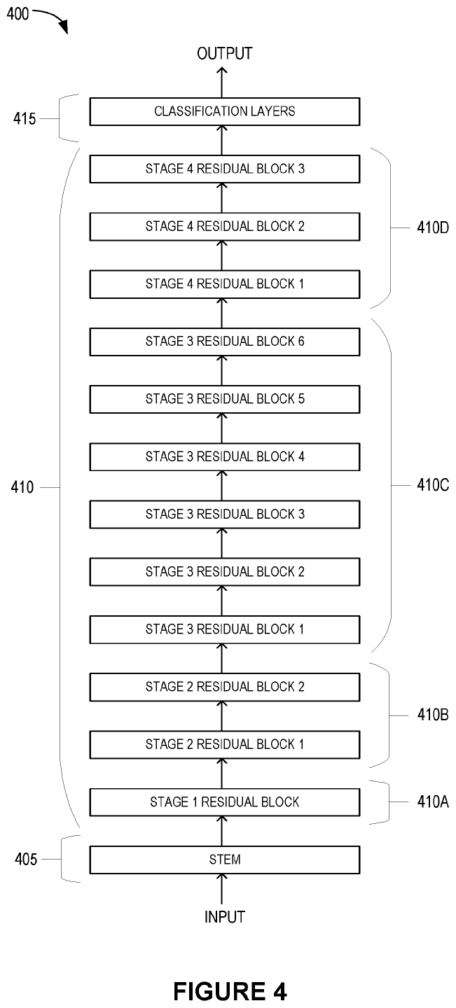

FIG. 4 provides a schematic illustration of a residual neural network architecture 400 which may be a normalizer-free neural network. The residual neural network 400 comprises an initial set of one or more hidden layers referred to as the “stem” 405. Following the stem, the residual neural network 400 comprises another set of hidden layers referred to as the “backbone” 410. Finally, the residual neural network 400 comprises a further set of one or more layers 415 which may be specific to the task being performed such as a classification layer.

The backbone 410 of the residual neural network 400 may comprise a plurality of repeating residual blocks. Each residual block may comprise the same sequence of operations (sequence of neural network layers) and there may be more than one type of residual block present. The residual blocks may be arranged into stages in which each stage comprises a sequence of residual blocks having constant width and resolution. In FIG. 4, the backbone 410 comprises a first stage 410A having one residual block, a second stage 410B having two residual blocks, a third stage 410C having six residual blocks and a fourth stage 410D having three residual blocks. The backbone 410 may comprise a number of residual blocks in the ratio 1:2:6:3 starting from the first stage to the fourth stage. Neural networks of increased depth may be constructed by increasing the numbers of residual blocks in each stage in keeping with the specified ratio. For example, a neural network may have five residual blocks in the first stage, ten residual blocks in the second, thirty in the third stage and fifteen in the fourth stage.

The width of each stage may be double the width of the previous stage. For example, the width may be 256 at the first stage, 512 at the second stage, 1024 at third stage and 2048 at the fourth stage. In an alternative configuration, the width of the third and fourth stages may be 1536. For example, the width may be 256 at the first stage, 512 at the second stage and 1536 at both the third and fourth stages. In another example, the width may be 256 at the first stage, 1024 at the second stage and 1536 at both the third and fourth stages. Transition blocks (not shown in FIG. 4) may be used between stages for handling the change in width.

As noted above, a residual block may comprise a non-linearity. The non-linearity may be a Gaussian Error Linear Unit (GELU) or Rectified Linear Unit (ReLU) or other appropriate non-linear operation. The convolution operation may be a grouped convolution. For example, the group width of 3×3 convolutions may be 128.

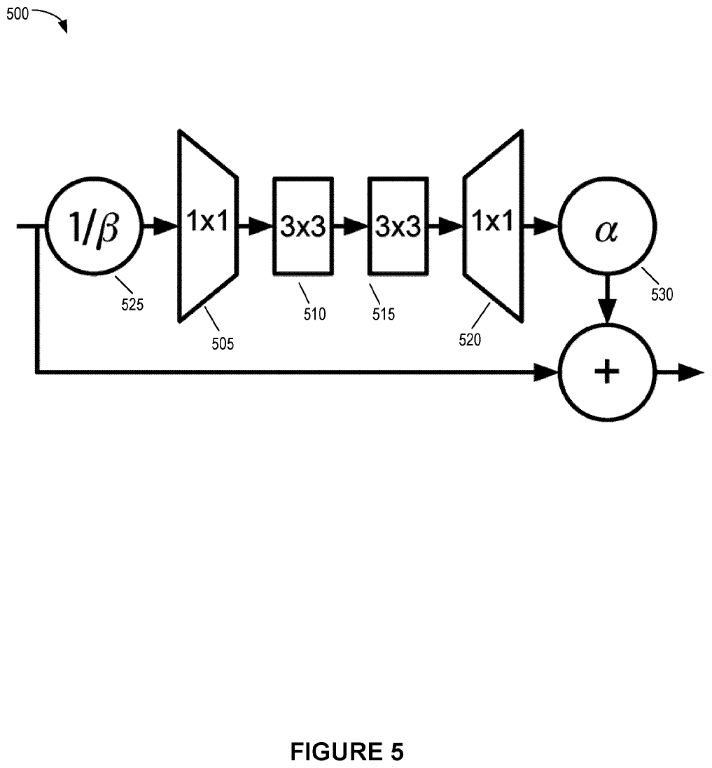

The residual block may be a bottleneck residual block. An exemplary bottleneck residual block 500 is shown in FIG. 5. The bottleneck residual block 500 comprises a 1×1 convolutional layer 505 that reduces the number of channels to form a bottleneck. For example, the number of channels may be halved. A first grouped convolutional layer 510 and a second grouped convolutional layer 515 are present within the bottleneck. A typical bottleneck only consists of one convolutional layer inside the bottleneck. It has been found that the inclusion of a second convolutional layer in the bottleneck can improve task performance with almost no impact on training time. In FIG. 5, the bottleneck comprises two 3×3 grouped convolutional layers 510, 515. A further 1×1 convolutional layer 520 is provided that restores the number of channels. A non-linearity (not shown in FIG. 5) may follow one or more of the convolution operations.

The residual block 500 also comprises two scaling parameters, β 525 and α 530. The β parameter 525 downscales the input of the residual block 500 and may be based upon a variance of the input. The variance may be determined analytically. The final activation of the residual branch (the path including the bottleneck) of the residual block 500 may be scaled by the α scalar parameter 530.

With the scaling parameters 525 and 530, the residual block 500 may implement a function of the form, hᵢ₊₁=hᵢ+αƒᵢ(hᵢ/βᵢ), where hᵢdenotes the inputs to the i-th residual block 500, and ho denotes the function computed by the i-th residual branch. The function may be parameterized to be variance preserving at initialization, such that Var(ƒᵢ(z))=Var(z) for all i. The scalar α 530 may be 0.2. The scalar βᵢ 525 may be determined by predicting the standard deviation of the inputs to the i-th residual block, βᵢ=\sqrt{Var(hᵢ)}, where Var(hᵢ₊₁)=Var(hᵢ)+α², except for transition blocks, for which the skip path operates on the downscaled input (hᵢ/βᵢ), and the expected variance is reset after the transition block to hᵢ₊₁=1+α². Further details may be found Brock et al., “Characterizing signal propagation to close the performance gap in unnormalized resnets”, in 9th International Conference on Learning Representations, ICLR, 2021 which is hereby incorporated by reference in its entirety.

The weights of the convolutional layers of the residual block 500 may undergo scaled weight standardization. That is, the weights may be reparametrized based upon the mean and standard deviation of the weights in the layer. Further details in relation to scaled weight standardization can be found in Brock et al., “Characterizing signal propagation to close the performance gap in unnormalized resnets”, in 9th International Conference on Learning Representations, ICLR, 2021 which is hereby incorporated by reference in its entirety.

A residual block may further comprise a Squeeze and Excite layer. The Squeeze and Excite layer may process an input activation according to the following sequence of functions: global average pooling, fully-connected linear function, scaled non-linear function, second fully-connected linear function, sigmoid function and linear scaling. For example, the output of the layer may be 2σ(FC(GELU(FC(pool(h)))))×h, where σ is a sigmoid function, FC are fully-connected linear functions, pool is a global average pooling and h is an input activation. The scalar multiplier of 2 may be used to maintain signal variance. In one example, a Squeeze and Excite layer is provided after the final 1×1 convolutional layer 520 and prior to the scaling by α 530.

A residual block may further comprise a learnable scalar gain at the end of the residual branch of the residual block. The learnable scalar may be initialized with a value of zero. The learnable scalar may be in addition to the scalar α 530 discussed above.

As discussed above, a residual neural network may comprise transition blocks between stages of the backbone. The transition block may have a similar form to the bottleneck residual block 500 shown in FIG. 5. The first 3×3 grouped convolutional layer 510 may however be modified to increase the stride value, for example, the convolution operation may use a stride of 2, in order to alter the width of the output activations. In addition, the skip path (the path that bypasses the bottleneck layers) may comprise a pooling layer and a 1×1 convolutional layer that alters the width. The skip path may also be modified to branch away after the β scaling 525 rather than before as in residual block 500.

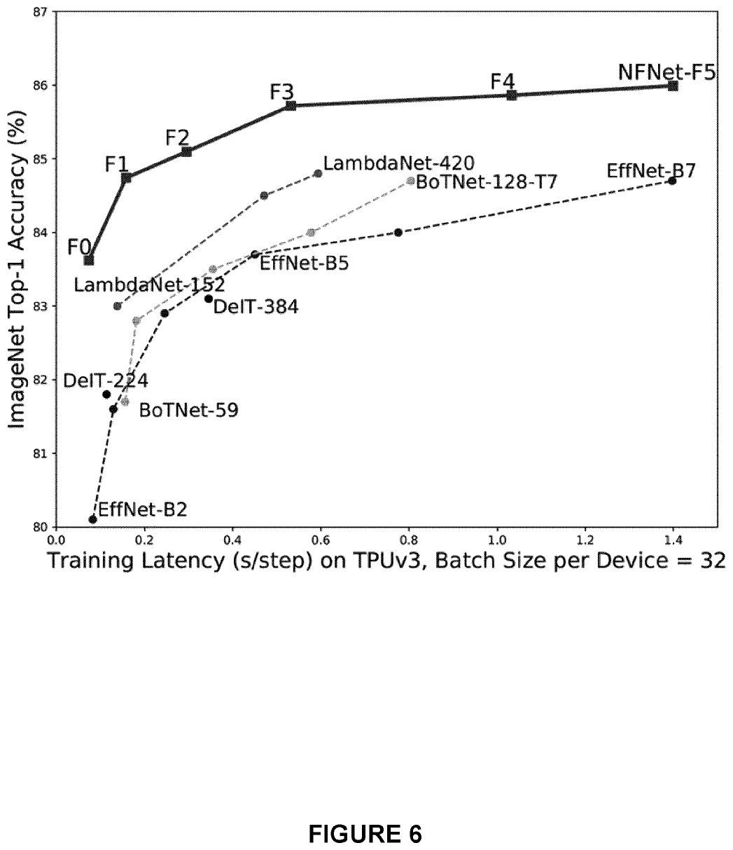

Referring now to FIG. 6, a plot of training latency against image recognition accuracy is shown comparing exemplary normalizer-free neural networks trained using the techniques described above (solid line) as compared to a representative sample of top-performing image recognition neural network models based upon residual neural networks (dashed lines). In more detail, the exemplary normalizer-free neural networks trained using the above techniques, labelled as NFNet-F0 to F5, comprise bottleneck residual blocks as shown in FIG. 5. Each exemplary neural network has a four stage backbone with a ratio of 1:2:6:3 as described above. The F0 neural network is the base network having the lowest number of residual blocks, i.e. 1, 2, 6 and 3 residual blocks in each respective stage. Each subsequent network has the next integer value in the ratio, i.e. the F1 neural network has 2, 4, 12 and 6 residual blocks in each respective stage, the F2 neural network has 3, 6, 18 and 9 residual blocks in each respective stage and so on. The width of each stage is [256, 512, 1536, 1536] starting from the first stage to fourth stage.

The plot in FIG. 6 shows the training latency measured as the median over 5000 training steps of the observed wall-clock time required to perform a single training step using a TPUv3 having 32 devices and a batch size of 32 training data items on each device. The neural networks are evaluated using the ImageNet top-1 accuracy benchmark.

As can be seen from FIG. 6, the exemplary normalizer-free neural networks provides greater image recognition accuracy whilst also being more efficient to train.

As noted above, the adaptive gradient clipping technique may be used for training a neural network to perform a particular task, examples of which are discussed below.

The neural network can be configured to receive any kind of digital data input and to generate any kind of score, classification, or regression output based on the input.

For example, if the inputs to the neural network are images or features that have been extracted from images, the output generated by the neural network for a given image may be scores for each of a set of object categories, with each score representing an estimated likelihood that the image contains an image of an object belonging to the category. That is, the neural network may perform an image/object recognition task. The neural network may also provide as output an indication of the location in the image of the detected object and thus may perform image segmentation.

As another example, if the input to the neural network is a sequence of text in one language, the output generated by the neural network may be a score for each of a set of pieces of text in another language, with each score representing an estimated likelihood that the piece of text in the other language is a proper translation of the input text into the other language.

As another example, if the input to the neural network is a sequence representing a spoken utterance, the output generated by the neural network may be a score for each of a set of pieces of text, each score representing an estimated likelihood that the piece of text is the correct transcript for the utterance.

More generally, the neural network may be used in a language modelling system, an image processing system, or an action selection system. The neural network may be used for supervised and unsupervised learning tasks. For example, the supervised learning tasks may include classification tasks, such as image processing tasks, speech recognition tasks, natural language processing tasks, word recognition tasks, or optical character recognition tasks. The unsupervised learning tasks may include reinforcement learning tasks where an agent interacts with one or more real or simulated environments to achieve one or more goals.

The input data to the neural network may comprise, for example, one or more of: image data, moving image/video data, motion data, speech data, audio data, an electronic document, data representing a state of an environment, and/or data representing an action. For example, the image data may comprise color or monochrome pixel value data. Such image data may be captured from an image sensor such as a camera or LIDAR sensor. The audio data may comprise data defining an audio waveform such as a series of values in the time and/or frequency domain defining the waveform; the waveform may represent speech in a natural language. The electronic document data may comprise text data representing words in a natural language. The data representing a state of an environment may comprise any sort of sensor data including, for example: data characterizing a state of a robot or vehicle, such as pose data and/or position/velocity/acceleration data; or data characterizing a state of an industrial plant or data center such as sensed electronic signals such as sensed current and/or temperature signals. The data representing an action may comprise, for example, position, velocity, acceleration, and/or torque control data or data for controlling the operation of one or more items of apparatus in an industrial plant or data center. These data may, generally, relate to a real or virtual, e.g. simulated, environment.

The output data of the neural network may similarly comprise any sort of data. For example in a classification system the output data may comprise class labels for input data items. In a regression task the output data may predict the value of a continuous variable, for example a control variable for controlling an electronic or electromechanical system such as a robot, vehicle, data center or plant. In another example of a regression task operating on image or audio data the output data may define one or more locations in the data, for example the location of an object or of one or more corners of a bounding box of an object or the time location of a sound feature in an audio waveform. In a reinforcement learning system the output data may comprise, for example, data representing an action, as described above, the action to be performed by an agent operating an in environment, for example a mechanical agent such as a robot or vehicle.

The data representing an action may comprise, for example, data defining an action-value (Q-value) for the action, or data parameterizing a probability distribution where the probability distribution is sampled to determine the action, or data directly defining the action, for example in a continuous action space. Thus in a reinforcement learning system the neural network may directly parameterize a probability distribution for an action-selection policy or it may learn to estimate values of an action-value function (Q-values). In the latter case multiple memories and respective output networks may share a common embedding network, to provide a Q-value for each available action.

Transformer neural networks are a type of self-attentive feed-forward sequence model. The Transformer neural network comprises an encoder and decoder. The encoder maps an input sequence to an encoding. The decoder processes the encoding to provide an output sequence. Examples of input and output sequences are provided below. Both the encoder and decoder use self-attention which guides the encoder/decoder to focus on the most relevant part of the sequence for the present time step and replaces the need for recurrent connections. Further details of the Transformer model can be found in Vaswani et al., “Attention Is All You Need”, 31st Conference on Neural Information Processing Systems (NIPS 2017), Long Beach, CA, USA, available at https://papers.nips.cc/paper/7181-attention-is-all-you-need.pdf which is hereby incorporated by reference in its entirety.

A Transformer neural network may be configured to receive an input sequence (i.e., a sequence of inputs each having a respective input at each of a plurality of input positions) and to process the input sequence to generate an output or output sequence.

For example, the Transformer neural network may be a part of a reinforcement learning system that selects actions to be performed by a reinforcement learning agent interacting with an environment. It will be appreciated that other types of neural network may be used in conjunction with a reinforcement learning system. In order for the agent to interact with the environment, the reinforcement learning system may receive an input sequence that includes a sequence of observations characterizing different states of the environment. The system may generate an output that specifies one or more actions to be performed by the agent in response to the received input sequence, i.e., in response to the last observation in the sequence. That is, the sequence of observations includes a current observation characterizing the current state of the environment and one or more historical observations characterizing past states of the environment.

In some implementations, the environment is a real-world environment and the agent is a mechanical agent interacting with the real-world environment. For example, the agent may be a robot interacting with the environment to accomplish a specific task, e.g., to locate an object of interest in the environment or to move an object of interest to a specified location in the environment or to navigate to a specified destination in the environment; or the agent may be an autonomous or semi-autonomous land or air or sea vehicle navigating through the environment.

In these implementations, the observations may include, for example, one or more of images, object position data, and sensor data to capture observations as the agent as it interacts with the environment, for example sensor data from an image, distance, or position sensor or from an actuator.

For example in the case of a robot the observations may include data characterizing the current state of the robot, e.g., one or more of: joint position, joint velocity, joint force, torque or acceleration, for example gravity-compensated torque feedback, and global or relative pose of an item held by the robot.

In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations.

The observations may also include, for example, sensed electronic signals such as motor current or a temperature signal; and/or image or video data for example from a camera or a LIDAR sensor, e.g., data from sensors of the agent or data from sensors that are located separately from the agent in the environment.

In the case of an electronic agent the observations may include data from one or more sensors monitoring part of a plant or service facility such as current, voltage, power, temperature and other sensors and/or electronic signals representing the functioning of electronic and/or mechanical items of equipment.

In these implementations, the actions may be control inputs to control the robot, e.g., torques for the joints of the robot or higher-level control commands, or the autonomous or semi-autonomous land or air or sea vehicle, e.g., torques to the control surface or other control elements of the vehicle or higher-level control commands.

In other words, the actions can include for example, position, velocity, or force/torque/acceleration data for one or more joints of a robot or parts of another mechanical agent. Action data may additionally or alternatively include electronic control data such as motor control data, or more generally data for controlling one or more electronic devices within the environment the control of which has an effect on the observed state of the environment. For example in the case of an autonomous or semi-autonomous land or air or sea vehicle the actions may include actions to control navigation such as steering, and movement, e.g. braking and/or acceleration of the vehicle.

In some implementations the environment is a simulated environment and the agent is implemented as one or more computers interacting with the simulated environment. Training an agent in a simulated environment may enable the agent to learn from large amounts of simulated training data while avoiding risks associated with training the agent in a real world environment, e.g., damage to the agent due to performing poorly chosen actions. An agent trained in a simulated environment may thereafter be deployed in a real-world environment.

For example the simulated environment may be a simulation of a robot or vehicle and the reinforcement learning system may be trained on the simulation. For example, the simulated environment may be a motion simulation environment, e.g., a driving simulation or a flight simulation, and the agent is a simulated vehicle navigating through the motion simulation. In these implementations, the actions may be control inputs to control the simulated user or simulated vehicle.

In another example, the simulated environment may be a video game and the agent may be a simulated user playing the video game.

In a further example the environment may be a chemical synthesis or a protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that performs or controls the protein folding actions selected by the system automatically without human interaction. The observations may include direct or indirect observations of a state of the protein and/or may be derived from simulation.

In a similar way the environment may be a drug design environment such that each state is a respective state of a potential pharma chemical drug and the agent is a computer system for determining elements of the pharma chemical drug and/or a synthetic pathway for the pharma chemical drug. The drug/synthesis may be designed based on a reward derived from a target for the drug, for example in simulation. As another example, the agent may be a mechanical agent that performs or controls synthesis of the drug.

In some applications the agent may be a static or mobile software agent i.e. a computer programs configured to operate autonomously and/or with other software agents or people to perform a task. For example the environment may be an integrated circuit routing environment and the system may be configured to learn to perform a routing task for routing interconnection lines of an integrated circuit such as an ASIC. The rewards (or costs) may then be dependent on one or more routing metrics such as an interconnect resistance, capacitance, impedance, loss, speed or propagation delay, physical line parameters such as width, thickness or geometry, and design rules. The observations may be observations of component positions and interconnections; the actions may comprise component placing actions e.g. to define a component position or orientation and/or interconnect routing actions e.g. interconnect selection and/or placement actions. The routing task may thus comprise placing components i.e. determining positions and/or orientations of components of the integrated circuit, and/or determining a routing of interconnections between the components. Once the routing task has been completed an integrated circuit, e.g. ASIC, may be fabricated according to the determined placement and/or routing. Or the environment may be a data packet communications network environment, and the agent be a router to route packets of data over the communications network based on observations of the network.

Generally, in the case of a simulated environment, the observations may include simulated versions of one or more of the previously described observations or types of observations and the actions may include simulated versions of one or more of the previously described actions or types of actions.

In some other applications the agent may control actions in a real-world environment including items of equipment, for example in a data center or grid mains power or water distribution system, or in a manufacturing plant or service facility. The observations may then relate to operation of the plant or facility. For example the observations may include observations of power or water usage by equipment, or observations of power generation or distribution control, or observations of usage of a resource or of waste production. The agent may control actions in the environment to increase efficiency, for example by reducing resource usage, and/or reduce the environmental impact of operations in the environment, for example by reducing waste. The actions may include actions controlling or imposing operating conditions on items of equipment of the plant/facility, and/or actions that result in changes to settings in the operation of the plant/facility e.g. to adjust or turn on/off components of the plant/facility.

In some further applications, the environment is a real-world environment and the agent manages distribution of tasks across computing resources e.g. on a mobile device and/or in a data center. In these implementations, the actions may include assigning tasks to particular computing resources.

In general, in the above described applications, where the environment is a simulated version of a real-world environment, once the system/method has been trained in the simulation it may afterwards be applied to the real-world environment. That is, control signals generated by the system/method may be used to control the agent to perform a task in the real-world environment in response to observations from the real-world environment. Optionally the system/method may continue training in the real-world environment based on one or more rewards from the real-world environment.

Optionally, in any of the above implementations, the observation at any given time step may include data from a previous time step that may be beneficial in characterizing the environment, e.g., the action performed at the previous time step, the reward received at the previous time step, and so on.

In another example, the Transformer neural network may be part of a neural machine translation system. That is, if the input sequence is a sequence of words in an original language, e.g., a sentence or phrase, the output may be a translation of the input sequence into a target language, i.e., a sequence of words in the target language that represents the sequence of words in the original language.

As another example, the Transformer neural network may be part of a speech recognition system. That is, if the input sequence is a sequence of audio data representing a spoken utterance, the output may be a sequence of graphemes, characters, or words that represents the utterance, i.e., is a transcription of the input sequence. As another example, if the input to the neural network is a sequence representing a spoken utterance, the output generated by the neural network can indicate whether a particular word or phrase (“hotword”) was spoken in the utterance. As another example, if the input to the neural network is a sequence representing a spoken utterance, the output generated by the neural network can identify the natural language in which the utterance was spoken. Thus in general the network input may comprise audio data for performing the audio processing task and the network output may provide a result of the audio processing task e.g. to identify a word or phrase or to convert the audio to text.

As another example, the Transformer neural network may be part of a natural language processing system. For example, if the input sequence is a sequence of words in an original language, e.g., a sentence or phrase, the output may be a summary of the input sequence in the original language, i.e., a sequence that has fewer words than the input sequence but that retains the essential meaning of the input sequence. As another example, if the input sequence is a sequence of words that form a question, the output can be/define a sequence of words that form an answer to the question. As another example, the task can be a natural language understanding task, e.g., an entailment task, a paraphrase task, a textual similarity task, a sentiment analysis task, a sentence completion task, a grammaticality task, and so on, that operates on a sequence of text in some natural language to generate an output that predicts some property of the text. Or auto-code generation from natural language (automatic generation of tensorflow code snippets from natural language). As another example, the task can be a text to speech task, where the input is text in a natural language or features of text in a natural language and the network output defines a spectrogram or comprises other data defining audio of the text being spoken in the natural language.

As another example, the task can be a text generation task, where the input is a sequence of text, and the output is another sequence of text, e.g., a completion of the input sequence of text, a response to a question posed in the input sequence, or a sequence of text that is about a topic specified by the first sequence of text. As another example, the input to the text generation task can be an input other than text, e.g., an image, and the output sequence can be text that describes the input.

As another example, the Transformer neural network may be part of a computer-assisted medical diagnosis system. For example, the input sequence can be a sequence of data from an electronic medical record and the output can be a sequence of predicted treatments.

As another example, the Transformer neural network may be part of an image processing system. For example, the input sequence can be an image, i.e., a sequence of color values from the image, and the output can be a sequence of text that describes the image or video. As another example, the input sequence can be a sequence of text or a different context and the output can be an image that describes the context.

Generative Adversarial Network (GAN) is a generative model trained using an adversarial process in which a generator network and a discriminator network are simultaneously trained. During training, the generator network produces samples which the discriminator network attempts to recognize as being generated by the generator network as opposed to being a real training data item. The result of the determination by the discriminator network is used as a learning signal for the generator network to improve its generation capability with the objective that the generated samples cannot be differentiated from real training data items. At the same time, the discriminator network is also trained to improve its detection capability and thus the two networks work in tandem to improve the generator network's capability. Further details can be found in Goodfellow et al., “Generative Adversarial Networks”, arXiv preprint arXiv: 1406.2661, 2014, available at https://arxiv.org/pdf/1406.2661.pdf which is hereby incorporated by reference in its entirety.

The generator may generate data items which may be data representing a still or moving image, in which case individual numerical values contained in the data item may represent pixel values, for example values of one or more color channels of the pixels. The training images used for training the discriminator network (and thereby training the generator network jointly with it) may be images of the real world, captured by a camera.

For example, in one implementation, a user may use the trained generator network to generate images (still or moving images) from an image distribution (e.g. a distribution reflecting a database of training images with which the generator network was produced, e.g. reflective of real-world images).

Alternatively the data item may be data representing a sound signal, for example amplitude values of an audio waveform (e.g. a natural language; the training examples in this case may be samples of natural language, e.g. recorded by a microphone from speech by human speakers). In another possibility, the data item may be text data, for example a text string or other representation of words and/or sub-word units (wordpieces) in a machine translation task. Thus the data item may be one, two, or higher-dimensional.

The generator network may generate the data item conditioned upon a conditional vector (target data) input to the generator network, representing a target for generating the data item. The target data may represent the same or a different type or modality of data to the generated data item. For example, when trained to generate image data the target data may define a label or class of one of the images and the generated data item may then comprise an example image of that type (e.g African elephant). Or the target data may comprise an image or an encoding of an image, and the generated data item may define another similar image—for example when trained on images of faces, the target data may comprise an encoding of a person's face and the generator network may then generate a data item representing a similar face with a different pose/lighting condition. In another example, the target data may show an image of a subject and include data defining a movement/change of a viewpoint, and the generator network could generate an image of the subject from the new viewpoint.

Alternatively, the target data may comprise a text string or spoken sentence, or an encoding of these, and the generator network may generate an image corresponding to the text or speech (text to image synthesis), or vice-versa. Alternatively the target data may comprise a text string or spoken sentence, or an encoding of these, and the generator network may then generate a corresponding text string or spoken sentence in a different language. The system may also generate video autoregressively, in particular given one or more previous video frames.

In another implementation, the generator network may generate sound data, for example speech, in a similar way. This may be conditioned upon audio data and/or other data such as text data. In general the target data may define local and/or global features of the generated data item. For example for audio data, the generator network may generate a sequence of outputs based on a series of target data values. For example, the target data may comprise global features (the same when the generator network is to generate a sequence of data items), which may comprise information defining the sound of a particular person's voice, or a speech style, or a speaker identity, or a language identity. The target data may additionally or alternatively comprise local features (i.e. not the same for the sequence of data items) which may comprise linguistic features derived from input text, optionally with intonation data.

In another example the target data may define motion or state of a physical object, for example actions and/or states of a robot arm. The generator network may then be used to generate a data item predicting a future image or video sequence seen by a real or virtual camera associated with the physical object. In such an example the target data may include one or more previous image or video frames seen by the camera. This data can be useful for reinforcement learning, for example facilitating planning in a visual environment. More generally the system learns to encode a probability density (i.e. the distribution) which may be used directly for probabilistic planning/exploration.

In still further examples, the generator network may be employed for image processing tasks such as de-noising, de-blurring, image completion and the like by employing target data defining a noisy or incomplete image; for image modification tasks by employing target data defining a modified image; and for image compression, for example when the generator network is used in an auto-encoder. The system may similarly be used to process signals representing other than images.

The input target data and output data item may in general be any kind of digital data. Thus in another example the input target data and output data item may each comprise tokens defining a sentence in a natural language. The generator network may then be used, for example, in a system for machine translation or to generate sentences representing a concept expressed in the latent values and/or additional data. The latent values may additionally or alternatively be used to control a style or sentiment of the generated text. In still further examples the input and output data item may comprise speech, video, or time series data generally.

In another example, the generator network may be used to generate further examples of data items for training another machine learning system. For example the generator network and discriminator network may be jointly trained on a set of data items and then the generator network is used generate new data items similar to those in the training data set. The set of latent values may be determined by sampling from the latent distribution of latent values. If the generator network has been trained conditioned on additional data, e.g. labels, new data items may be generated conditioned on additional data e.g. a label provided to the generator network. In this way additional labelled data items may be generated, for example to supplement a dearth of unlabeled training data items.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them. The computer storage medium is not, however, a propagated signal.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows can be performed by and apparatus can also be implemented as a graphics processing unit (GPU).

Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

1. A computer-implemented method for training a neural network comprising:
determining a gradient associated with a parameter of the neural network;
determining a ratio of a gradient norm to parameter norm;
comparing the ratio to a threshold;
in response to determining that the ratio exceeds the threshold, reducing the value of the gradient such that the ratio is equal to or below the threshold; and
updating the value of the parameter based upon the reduced gradient value.

2. The method of claim 1, further comprising:
in response to determining that the ratio is below the threshold, maintaining the value of the gradient and updating the value of the parameter based upon the maintained gradient value.

3. The method of claim 1, wherein reducing the value of the gradient comprises multiplying the value of the gradient by a scale factor based upon the threshold to reduce the value of the gradient.

4. The method of claim 1, wherein reducing the value of the gradient comprises multiplying the value of the gradient by a scale factor based upon the ratio to reduce the value of the gradient.

5. The method of claim 1, comprising determining the gradient norm and the parameter norm based upon the parameters associated with one neuron of the neural network.

6. The method of claim 5, wherein the parameter of the neural network is a weight connected to the neuron of the neural network, the method comprising determining the gradient norm based upon a gradient associated with each respective weight connected to the neuron, and determining the parameter norm based upon the weight values of each respective weight connected to the neuron.

7. The method of claim 6, further comprising computing the gradient norm as a Frobenius norm over the gradients associated with the respective weights connected to the neuron, and computing the parameter norm as a Frobenius norm over the respective weights connected to the neuron.

8. The method of claim 1, wherein reducing the value of the gradient is based upon the following equation:
$$\\ {G}_{i}^{{}^{} l} \to λ \frac{{‖ {W}_{i}^{{}^{} l} ‖}_{F}}{{‖ {G}_{i}^{{}^{} l} ‖}_{F}} {G}_{i}^{{}^{} l} if \frac{{‖ {G}_{i}^{{}^{} l} ‖}_{F}}{{‖ {W}_{i}^{{}^{} l} ‖}_{F}} > λ$$
where W^{l} is a weight matrix for the l-th layer, i is an index of a neuron in the l-th layer, Gᵢ^{l} is the gradient corresponding to parameters Wᵢ^{l}, λ is a scalar threshold and ∥·∥_{F} is the Frobenius norm.

9. The method of claim 1, wherein the neural network comprises a residual block and wherein the residual block is normalization layer free.

10. The method of claim 1, wherein the neural network is a deep residual neural network comprising a four stage backbone.

11. The method of claim 10, wherein the backbone comprises residual blocks in the ratio 1:2:6:3 starting from the first stage to the fourth stage.

12. The method of claim 10, wherein the width of each stage is double the width of the previous stage.

13. The method of claim 9, wherein the residual block is a bottleneck residual block.

14. The method of claim 1, wherein the neural network is a Transformer type neural network.

15. The method of claim 1, wherein updating the value of the parameter is based upon a batch size of at least 1024 training data items.

16. The method of claim 1, wherein the neural network has been pre-trained.

17. The method of claim 1, further comprising receiving a training dataset comprising image data and wherein determining a gradient is based upon a loss function for measuring the performance of the neural network on an image processing task.

18. The method of claim 1, wherein the method is performed by a parallel or distributed processing system comprising a plurality of processing units, the method further comprising:
receiving a training data set comprising a plurality of training data items;
generating a plurality of batches of training data items, each batch comprising a subset of the training data items of the training data set;
distributing the plurality of batches of training data items to the plurality of processing units; and
training the neural network, using the plurality of processing units in parallel, based upon the distributed plurality of batches of training data items.

19.-23. (canceled)

24. A system comprising:
one or more computers; and
one or more storage devices communicatively coupled to the one or more computers, wherein the one or more storage devices store instructions that, when executed by the one or more computers, cause the one or more computers to perform operations for training a neural network, the operations comprising:
determining a gradient associated with a parameter of the neural network;
determining a ratio of a gradient norm to parameter norm;
comparing the ratio to a threshold;
in response to determining that the ratio exceeds the threshold, reducing the value of the gradient such that the ratio is equal to or below the threshold; and
updating the value of the parameter based upon the reduced gradient value.

25. One or more non-transitory computer storage media storing instructions that when executed by one or more computers cause the one or more computers to perform operations for training a neural network, the operations comprising:
determining a gradient associated with a parameter of the neural network;
determining a ratio of a gradient norm to parameter norm;
comparing the ratio to a threshold;
in response to determining that the ratio exceeds the threshold, reducing the value of the gradient such that the ratio is equal to or below the threshold; and
updating the value of the parameter based upon the reduced gradient value.
